(19) United States
(12) Patent Application Publication
(10) Pub. No.: US 2026/0089030 A1
(43) Pub. Date: Mar. 26, 2026

(54) SIGNAL TRANSMISSION SYSTEM

(71) Applicant: MITSUBISHI ELECTRIC CORPORATION, Tokyo (JP)

(72) Inventors: Koji MIYAGAWA, Tokyo (JP); Tetsu OWADA, Tokyo (JP)

(73) Assignee: MITSUBISHI ELECTRIC CORPORATION, Tokyo (JP)

(21) Appl. No.: 19/406,682

(22) Filed: Dec. 2, 2025

Related U.S. Application Data
(63) Continuation of application No. PCT/JP2023/025215, filed on Jul. 7, 2023.

(51) Int. Cl. H04L 25/02

(52) U.S. Cl. CPC H04L 25/02

(57) ABSTRACT

A signal transmission system includes: a wiring conductor that is formed elliptically, and has two focal points; a GND conductor board disposed facing the wiring conductor; a driver connected between a first focal point of the wiring conductor and the GND conductor board; a plurality of receivers connected between the wiring conductor and the GND conductor board; and a termination circuit connected between a second focal point of the wiring conductor and the GND conductor board.

### CROSS REFERENCE TO RELATED APPLICATION

This application is a Continuation of PCT International Application No. PCT/JP2023/025215, filed on Jul. 7, 2023, which is hereby expressly incorporated by reference into the present application.

### TECHNICAL FIELD

The present disclosure relates to a signal transmission system.

### BACKGROUND ART

In one of signal transmission systems applied to printed boards, a driver IC and a receiver IC are connected by a wire, and a termination resistor (or a termination circuit) is provided near the receiver IC. In a case where a bus wiring scheme including a main line and a branch line is adopted for such a signal transmission system, a signal input to a branch line from the main line repeats being reflected at the branch point or in the branch line, in some cases. Because of this, the waveform of the signal is distorted due to the effect of the multiple reflections undesirably, and the signal quality is degraded. As a result, it becomes difficult to achieve normal signal transmission.

As a countermeasure, a technology to insert a resistor on a branch line has been provided. Such a conventional signal transmission system is disclosed in Patent Literature 1, for example.

### CITATION LIST

### Patent Literature

Patent Literature 1: JP H11-4263 A

### SUMMARY OF INVENTION

### Technical Problem

However, since multiple reflections of signals are reduced using a resistor in the signal transmission system disclosed in Patent Literature 1, the amplitude of signals decreases undesirably as the number of branch lines increases (as the number of receiver ICs increases).

The present disclosure has been made in order to solve the problem described above, and an object thereof is to provide a signal transmission system that can eliminate multiple reflections, and prevent the reduction of the amplitude of received signals, even in a case where a plurality of receivers are included for one driver.

### Solution to Problem

A signal transmission system according to the present disclosure includes: a wiring conductor whose outer circumference is formed elliptically, and has two focal points, and that is board shaped; a ground conductor that is disposed facing the wiring conductor; a driver that is connected between a first focal point of the focal points of the wiring conductor and the ground conductor; a plurality of receivers that are connected between the wiring conductor and the ground conductor; and a termination circuit that is connected between a second focal point of the focal points of the wiring conductor and the ground conductor.

### Advantageous Effects of Invention

The present disclosure can eliminate multiple reflections, and prevent the reduction of the amplitude of received signals, even in a case where a plurality of receivers are included for one driver.

### BRIEF DESCRIPTION OF DRAWINGS

FIG. 1 is a schematic configuration diagram of a signal transmission system according to a first embodiment.

FIG. 2A and FIG. 2B are schematic diagrams illustrating the connection structure of a driver. FIG. 2A is a plan view of the connection structure of the driver. FIG. 2B is a cross-sectional view taken along a plane represented by arrows II-II in FIG. 2A.

FIG. 3 is a plan view illustrating the state of signal transmission.

FIG. 4 is a schematic configuration diagram of a signal transmission system according to a second embodiment.

FIG. 5 is a schematic configuration diagram of a signal transmission system according to a third embodiment.

FIG. 6 is a schematic configuration diagram of a conventional signal transmission system.

### DESCRIPTION OF EMBODIMENTS

Hereinbelow, modes for implementing the present disclosure are explained with reference to the attached drawings in order to explain the present disclosure in more detail.

### First Embodiment.

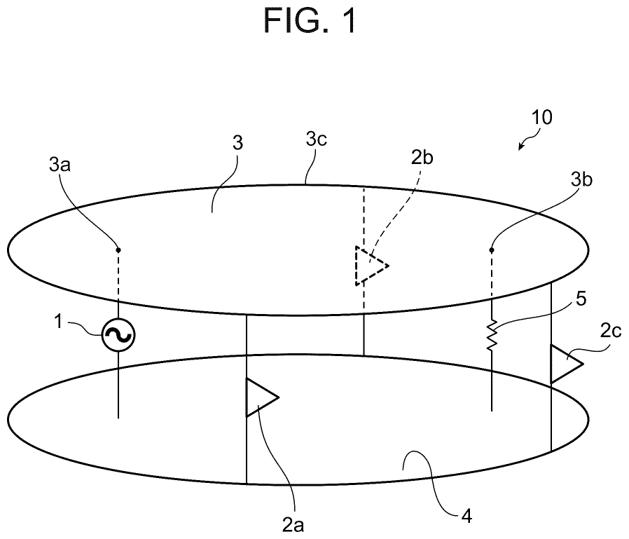

A signal transmission system 10 according to a first embodiment is explained using FIG. 1 to FIG. 3.

First, before the signal transmission system 10 according to the first embodiment is explained, a typical signal transmission system 50 that is applied to a printed board is explained using FIG. 6. FIG. 6 is a schematic configuration diagram of the conventional signal transmission system 50.

As illustrated in FIG. 6, the signal transmission system 50 includes a driver 51, a receiver 52, a wiring conductor 53, a GND conductor board 54, and a termination circuit 55. Such a signal transmission system 50 is provided on a printed board (not illustrated), for example.

Specifically, the driver 51 and the receiver 52 are implemented on the surface of the printed board (not illustrated). The driver 51 and the receiver 52 are integrated circuits such as Integrated Circuits (ICs), for example. The driver 51 and the receiver 52 are connected by the linear wiring conductor 53. The GND conductor board 54 is disposed below the wiring conductor 53. A dielectric (not illustrated) is interposed between the wiring conductor 53 and the GND conductor board 54. In addition, the termination circuit 55 is implemented, near the receiver 52, to the wiring conductor 53. The termination circuit 55 connects the wiring conductor 53 and the GND conductor board 54.

Note that the termination circuit 55 is built in the receiver 52, in some cases. In addition, the termination circuit 55 is a termination resistor, for example.

Accordingly, a signal output from the driver 51 is transmitted through the wiring conductor 53, and thereafter reaches the receiver 52 and the termination circuit 55. By absorbing the signal, the termination circuit 55 reduces signal degradation caused by multiple reflections. In addition, the termination circuit 55 senses the voltage amplitude of the signal received by the receiver 52. Because of this, the signal transmission system 50 enables favorable signal transmission between the driver 51 and the receiver 52 without the occurrence of reflection waves.

Here, in a case where a signal transmission scheme that enables transmission of signals from the one driver 51 toward a plurality of the receivers 52 is adopted for the signal transmission system 50, there is a possibility that signal reflections occur at branch portions on the wiring conductor 53. If signal reflections occur in this manner, the quality of the signals lowers, and, in addition to this, the amplitude of the signals is reduced as the number of the termination circuits 55 increases, undesirably. In order to solve such problems, it is conceivable that the number of the termination circuits 55 is reduced. However, if the number of the termination circuits 55 is reduced, signals are reflected undesirably at wiring ends where the receivers 52 are connected, thereby significantly lowering the signal quality.

In contrast, as illustrated in FIG. 1, the signal transmission system 10 according to the first embodiment includes one driver 1, a plurality of receivers 2a, 2b, and 2c, a wiring conductor 3, a GND conductor board (ground conductor) 4, and a termination circuit 5. Such a signal transmission system 10 is provided on a printed board, for example.

Specifically, the driver 1, the receivers 2a, 2b, and 2c, and the termination circuit 5 are connected between the wiring conductor 3 and the GND conductor board 4. The wiring conductor 3 and the GND conductor board 4 are arranged facing each other.

That is, a first end of the driver 1 is connected to the wiring conductor 3, and a second end of the driver 1 is connected to the GND conductor board 4. First ends of the receivers 2a, 2b, and 2c are connected to the wiring conductor 3, and second ends of the receivers 2a, 2b, and 2c are connected to the GND conductor board 4. A first end of the termination circuit 5 is connected to the wiring conductor 3, and a second end of the termination circuit 5 is connected to the GND conductor board 4.

Note that the driver 1 and the receivers 2a, 2b, and 2c are integrated circuits such as Integrated Circuits (ICs), for example. In addition, FIG. 1 illustrates an example of the signal transmission system 10 including the three receivers 2a, 2b, and 2c. It is sufficient if the number of receivers is two or greater.

The wiring conductor 3 is an elliptical flat conductor. The wiring conductor 3 has two focal points 3a and 3b. The first end of the driver 1 is connected to the first focal point 3a of the wiring conductor 3. The first end of the termination circuit 5 is connected to the second focal point 3b of the wiring conductor 3. In addition, the first ends of the receivers 2a, 2b, and 2c are connected to an outer circumferential edge 3c of the wiring conductor 3. The positions at which the first ends of the receivers 2a, 2b, and 2c are connected to the wiring conductor 3 may be any positions as long as the positions are at the outer circumferential edge 3c.

The GND conductor board 4 is disposed below the wiring conductor 3. The wiring conductor 3 and the GND conductor board 4 are arranged parallel to each other. A dielectric (not illustrated) is interposed between the wiring conductor 3 and the GND conductor board 4. The GND conductor board 4 has an elliptical shape and a size which are the same as the wiring conductor 3. Note that it is sufficient if the GND conductor board 4 has a size which is equal to or greater than the size of the wiring conductor 3.

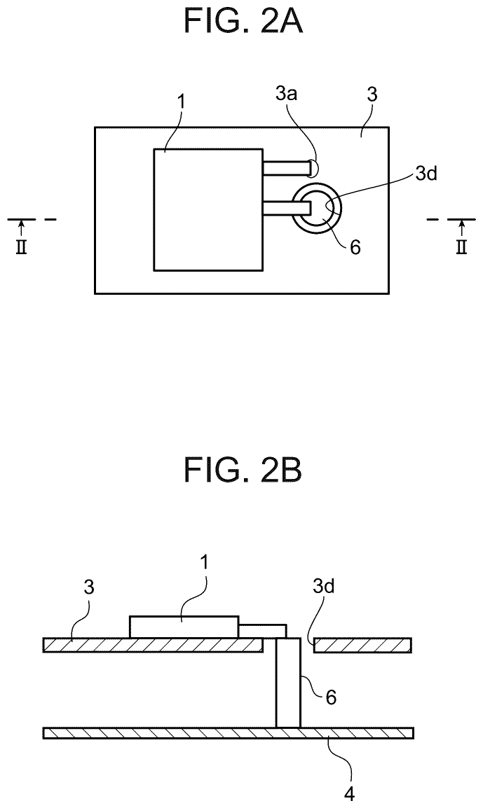

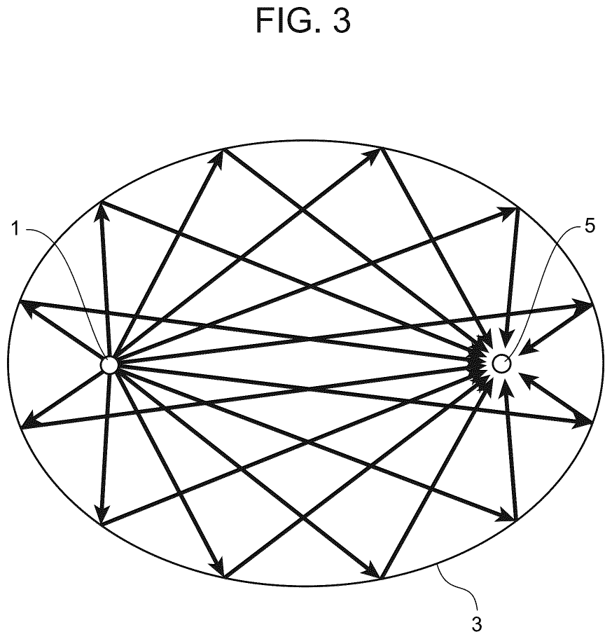

Note that the driver 1, the receivers 2a, 2b, and 2c, and the termination circuit 5 are illustrated as being arranged between the wiring conductor 3 and the GND conductor board 4 in FIG. 1, but actually have connection structures illustrated in FIG. 2. The connection structures of the driver 1, the receivers 2a, 2b, and 2c, and the termination circuit 5 are identical. Accordingly, FIG. 2 representatively illustrates the connection structure of the driver 1.

As illustrated in FIG. 2, the driver 1 is provided on the wiring conductor 3. One terminal of the driver 1 is connected to the first focal point 3a. The other terminal of the driver 1 is connected to the GND conductor board 4 via a via 6. The via 6 reaches the GND conductor board 4 through a through-hole 3d formed through the wiring conductor 3. At this time, the via 6 is not in contact with the through-hole 3d.

Accordingly, as illustrated in FIG. 3, signals output from the driver 1 are diffused in all directions in a parallel flat board including the wiring conductor 3 and the GND conductor board 4. At this time, since the parallel flat board is elliptical, the signals having been diffused in the elliptical flat board are reflected once at the outer circumferential edge of the elliptical flat board, and thereafter converge at the second focal point 3b. Since the termination circuit 5 is provided at the focal point 3b, all the signals are absorbed by the termination circuit 5. In this manner, signal reflections occur once at the outer circumferential edge 3c of the wiring conductor 3 (parallel flat board). Because of this, the receivers 2a, 2c, and 2b connected to the outer circumferential edge 3c do not each receive multiple times of signal reflections.

Therefore, the signal transmission system 10 can achieve favorable signal transmission without being affected by multiple reflections even in a signal transmission scheme in which a plurality of the receivers 2a, 2b, and 2c are included for the one driver 1. In addition, since there is still only one termination circuit 5 even when the number of the receivers 2a, 2b, and 2c increases, the signal transmission system 10 can prevent the reduction of the amplitude of received signals. Furthermore, since a complex control circuit and the like are also not necessary, the signal transmission system 10 allows for a reduction in manufacturing costs.

Note that there are no problems even when the outer circumferential edge 3c of the wiring conductor 3 and the outer circumferential edge of the GND conductor board 4 are connected by a plurality of vias in the signal transmission system 10. In this case, it is assumed that signals are modulated signals not including DC components, and the receivers 2a, 2b, and 2c can sense the current values of the modulated signals. Because of this, the signal transmission system 10 can reduce unwanted radiation from the side surface of the parallel flat board.

In addition, the signal transmission system 10 can be applied not only to a board, but also to a cloth, a sheet, and the like.

As explained above, the signal transmission system 10 according to the first embodiment can eliminate multiple reflections, and prevent the reduction of the amplitude of received signals even in a case where a plurality of the receivers 2a, 2b, and 2c are included for the one driver 1.

### Second Embodiment.

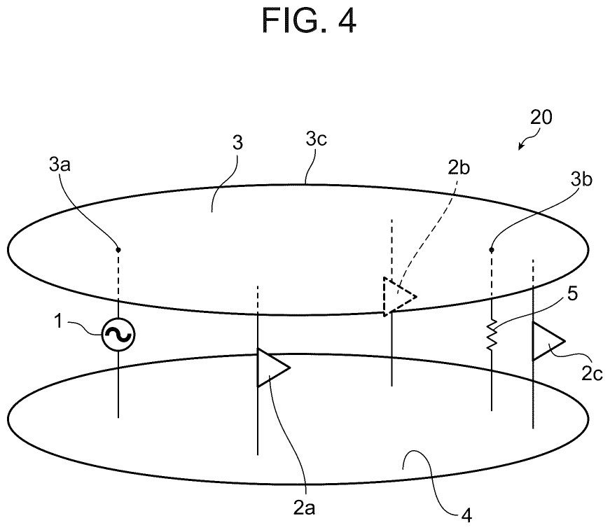

A signal transmission system 20 according to a second embodiment is explained using FIG. 4.

In the signal transmission system 10 according to the first embodiment, all the receivers 2a, 2b, and 2c are connected to the outer circumferential edge 3c of the elliptical wiring conductor 3. In contrast, as illustrated in FIG. 4, in the signal transmission system 20 according to the second embodiment, all receivers 2a, 2b, and 2c are connected on the inner side of an outer circumferential edge 3c of an elliptical wiring conductor 3.

Accordingly, signals output from a driver 1 are diffused in all directions in a parallel flat board including the wiring conductor 3 and a GND conductor board 4. At this time, since the parallel flat board is elliptical, the signals having been diffused in the elliptical flat board are reflected once at the outer circumferential edge of the elliptical flat board, and thereafter converge at a second focal point 3b. Since a termination circuit 5 is provided at the focal point 3b, all the signals are absorbed by the termination circuit 5. In this manner, signal reflections occur once at the outer circumferential edge 3c of the wiring conductor 3 (parallel flat board). Because of this, the receivers 2a, 2c, and 2b connected on the inner side of the outer circumferential edge 3c do not each receive multiple times of signal reflections.

As explained above, in the signal transmission system 20 according to the second embodiment, the receivers 2a, 2b, and 2c are connected on the inner side of the outer circumferential edge 3c of the wiring conductor 3. Accordingly, the degree of freedom of arrangement of the receivers 2a, 2b, and 2c can be increased significantly.

### Third Embodiment.

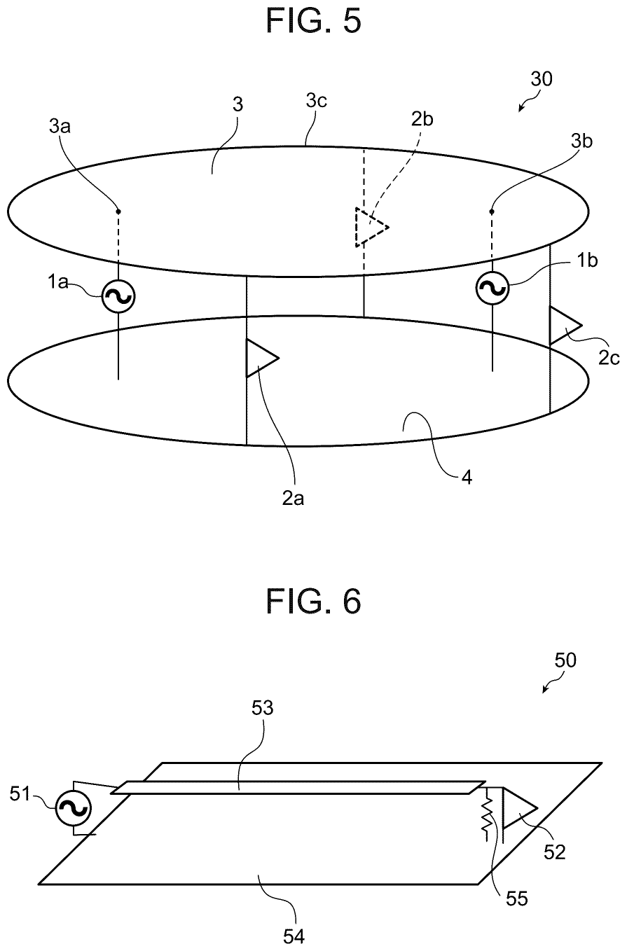

A signal transmission system 30 according to a third embodiment is explained using FIG. 5.

The signal transmission system 30 according to the third embodiment includes a driver 1 instead of the termination circuit 5 in the signal transmission system 10 according to the first embodiment. Note that one of the drivers 1 that is connected to a focal point 3a is treated as a first driver 1a, and the other one of the drivers 1 that is connected to a focal point 3b is treated as a second driver 1b.

The drivers 1a and 1b have input impedance which is the same as the input impedance of the termination circuit 5. Because of this, the driver 1b can operate as the termination circuit 5. Because of this, signals can be output from both the driver 1a and the driver 1b.

As explained above, the signal transmission system 30 according to the third embodiment can eliminate multiple reflections, and prevent the reduction of the amplitude of received signals, even in a case where a plurality of the receivers 2a, 2b, and 2c are included for the one driver 1a or the one driver 1b.

Note that the present disclosure allows for any combinations of the embodiments, modifications of any constituent elements in each embodiment, and omissions of any constituent elements in each embodiment within the scope of the disclosure.

### INDUSTRIAL APPLICABILITY

The signal transmission systems according to the present disclosure can eliminate multiple reflections, and prevent the reduction of the amplitude of received signals, even in a case where a plurality of receivers are included for one driver, and are suited for use as or in printed boards and the like.

### REFERENCE SIGNS LIST

1, 1a, 1b: Driver; 2a, 2b, 2c: Receiver; 3: Wiring conductor; 3a, 3b: Focal point; 3c: Outer circumferential edge; 3d: Through-hole; 4: GND conductor board; 5: Termination circuit; 10, 20, 30: Signal transmission system

1. A signal transmission system comprising:
a wiring conductor whose outer circumference is formed elliptically, and has two focal points, and that is board shaped;
a ground conductor that is disposed facing the wiring conductor;
a driver that is connected between a first focal point of the focal points of the wiring conductor and the ground conductor;
a plurality of receivers that are connected between the wiring conductor and the ground conductor; and
a termination circuit that is connected between a second focal point of the focal points of the wiring conductor and the ground conductor.

2. The signal transmission system according to claim 1, wherein the plurality of receivers are connected to an outer circumferential edge of the wiring conductor.

3. The signal transmission system according to claim 1, wherein the plurality of receivers are connected on an inner side of an outer circumferential edge of the wiring conductor.

4. The signal transmission system according to claim 1, wherein the termination circuit is a termination resistor.

5. The signal transmission system according to claim 1, wherein a second driver is provided instead of the termination circuit.

6. The signal transmission system according to claim 1, comprising a via that connects an outer circumferential edge of the wiring conductor and an outer circumferential edge of the ground conductor, wherein
the ground conductor is a board shaped conductor whose outer circumference is formed elliptically,
a signal output from the driver is a modulated signal not including a DC component, and
the plurality of receivers sense a current value of the modulated signal.

7. The signal transmission system according to claim 1, wherein the wiring conductor, the ground conductor, the driver, the receivers, and the termination circuit are implemented on a surface of any one of a printed board, a cloth, and a sheet.
